(19) United States
(12) Patent Application Publication
(10) Pub. No.: US 2013/0195740 A1
(43) Pub. Date: Aug. 1, 2013

(54) FILTER FOR REMOVAL OF HEAVY METALS

(71) Applicants: Shulong Li, Spartanburg, SC (US); David E. Wenstrup, Greer, SC (US)

(72) Inventors: Shulong Li, Spartanburg, SC (US); David E. Wenstrup, Greer, SC (US)

(21) Appl. No.: 13/362,376

(22) Filed: Jan. 31, 2012

(51) Int. Cl. B01D 53/64; B01D 67/00

(52) U.S. Cl. 423/210; 422/180; 427/244

(57) ABSTRACT

A filter containing a first textile and an abating chemistry. The first textile has a first side and a second side and is a non-woven, woven, or knit textile having an air permeability of between about 1 and 200 cfm. The abating chemistry is on at least the second side of the first textile and contains an adsorbent agent, an organic halogen producing agent, and optionally a binder.

### FIELD OF THE INVENTION

The present invention generally relates to filters. More particularly the invention relates to air filters that abate heavy metals.

### BACKGROUND

Coal-fired power generation plants, municipal waste incinerators, and oil refinery plants generate huge amounts of flue gases that contain substantial varieties and quantities of environmental pollutants, such as sulfur oxides (SO₂, and SO₃), nitrogen oxides (NO, NO₂), and heavy metals such as mercury (Hg) vapor.

The destructive effects of various coal-burning pollutants on human health and on the ecosystem were recognized a long time ago. For example, SOₓ and NOₓ have been linked to the outbreak of respiratory diseases in the affected areas. They also form acid rains, which damage forests, fisheries, and architectures. As for Hg, it is a potent toxin to the nervous system. Exposure to mercury can affect the brain, spinal cord, and other vital organs. It is particularly dangerous to developing fetuses and young children.

Mercury and other pollutants can be captured and removed from a flue gas stream by injection of a sorbent into the exhaust stream with subsequent collection in a particulate matter control device such as an electrostatic precipitator or a fabric filter. Adsorptive capture of Hg from flue gas is a complex process that involves many variables. These variables include the temperature and composition of the flue gas, the concentration and speciation of Hg in the exhaust stream, residence time, and the physical and chemical characteristics of the sorbent.

Currently, the most commonly used method for mercury emission reduction is the injection of powdered activated carbon (PAC) into the flue stream of coal-fired and oil-fired plants. Coal-fired combustion flue gas streams are of particular concern because their composition includes trace amounts of acid gases, including SO₂ and SO₃, NO and NO₂, and HCl. Some of these acid gases, such as SO₃, have been shown to degrade the performance of activated carbon. Though powdered activated carbon (PAC) is somewhat effective to capture oxidized mercury species such as Hg²⁺, PAC is not as effective for elemental mercury, which constitutes a major Hg species in flue gas, especially for subbituminous coals and lignite. Therefore, there is a need to provide a filter system that can abate the heavy metals such as mercury for a low cost.

### BRIEF SUMMARY

The present invention provides a filter containing a first textile and an abating chemistry. The first textile has a first side and a second side and is a non-woven, woven, or knit textile having an air permeability of between about 1 and 200 cfm. The abating chemistry is on at least the second side of the first textile and contains an adsorbent agent, an organic halogen producing agent, and optionally a binder.

### BRIEF DESCRIPTION OF THE DRAWINGS

FIG. 1 illustrates schematically a cross-section of an exemplary filter having a first textile and an abating chemistry.

FIG. 2 illustrates schematically a cross-section of an exemplary filter having a first textile, a membrane, and an abating chemistry.

FIG. 3 illustrates schematically a cross-section of an exemplary filter having two textiles and an abating chemistry.

### DETAILED DESCRIPTION

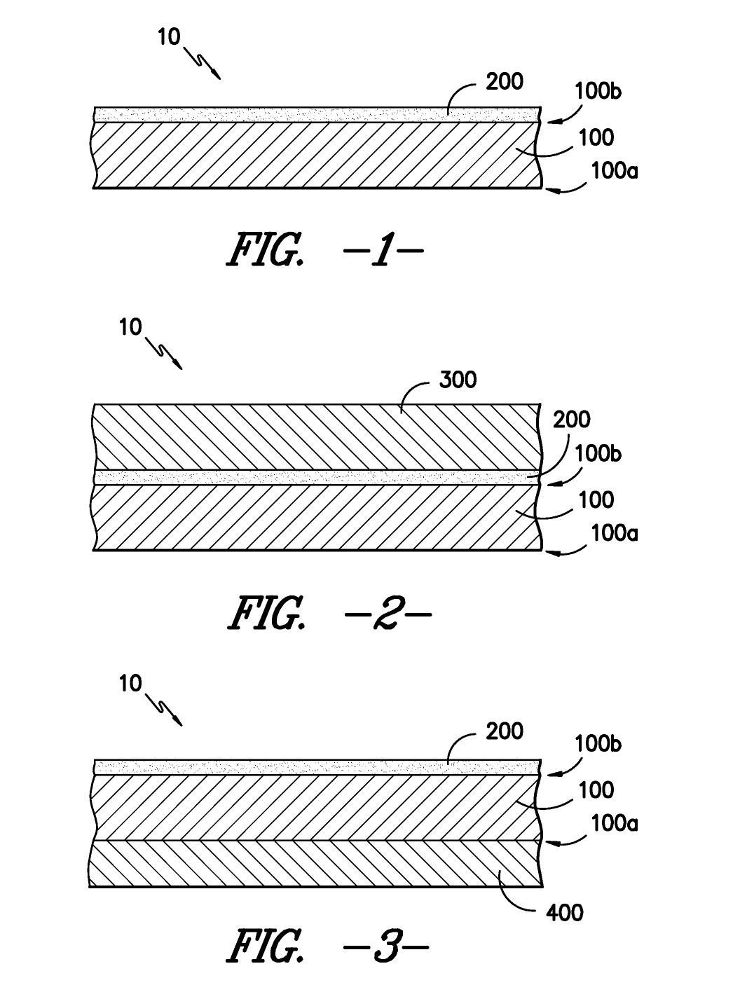

Referring now to FIG. 1, there is shown an embodiment of the filter 10 having a first textile 100 and an abating chemistry 200. The first textile has a first side 100a and a second side 100b. Typically the filter is oriented so that the flow of material to be filtered enters the first textile 100 on the first side 100a and exits the second side 100b. The air then passes through the abating chemistry 200 which is shown on the second side 100b of the first textile 100.

The filter 10, in one embodiment, has an air permeability of between about 1 and 5 cfm. The filter 10 preferably has a thickness of between 0.2 and 10 mm and is preferably flexible enough to allow the filter to be formed into various 3 dimensional shapes for different end uses. In one use the filter is used in elevated temperature environments such as in a bag house for filtering flue gas from a coal fired plant or smelting process to remove heavy metals such as mercury. The filter, for example, may be formed into bag-like shapes, formed into cartridges, or used in a flat state.

The first textile 100 may be any textile suitable for the desired end use. The first textile may be a woven, non-woven, or knit textile. In one embodiment, the first textile 100 is a woven textile. The weave may be, for example, plain, satin, twill, basket-weave, poplin, jacquard, and crepe weave textiles. Certain woven textiles, such as glass fiber or PPS fiber based woven textiles, alone or in combination with a non-woven textile, can provide higher mechanical strength.

In another embodiment, the first textile 100 is a knit textile, for example a circular knit, reverse plaited circular knit, double knit, single jersey knit, two-end fleece knit, three-end fleece knit, terry knit or double loop knit, weft inserted warp knit, warp knit, and warp knit with or without a micro-denier face. The loop pile of a knit textile may be flexible and move enough that the action may aid in releasing the dust cake from the filter. In another embodiment, the first textile is a multi-axial, such as a tri-axial textile (knit, woven, or non-woven). In another embodiment, the first textile is a bias textile. In another embodiment, the first textile is a unidirectional textile and may have overlapping yarns or may have gaps between the yarns.

In another embodiment, the first textile 100 is a non-woven textile. The term “non-woven” refers to structures incorporating a mass of yarns or fibers that are entangled and/or heat fused so as to provide a coordinated structure with a degree of internal coherency. Non-woven textiles may be formed from many processes such as for example, meltspun processes, hydroentangeling processes, mechanically entangled processes, stitch-bonding processes and the like. Non-woven textiles are typically less expensive to manufacture and can provide a selected pore structures useful for a filter medium. The randomness of the fiber orientation allows one to achieve a very uniform mean pore size and the amount of mass in the nonwoven can be built up until you achieve a wide range of desired mean pore sizes.

The textile has varying properties related to its desired end use. In one embodiment, the textile has an air permeability of between about 1 and 200 cfm (cubic feet per minute). This air permeability range has been shown to suitable produce filters for flue gasses coming from coal fired power plants and other air filtration needs. More preferably, the first textile 100 has an air permeability of between about 25 and 50 cfm measured at 125 Pa according to ASTM D737-04(2008) Standard Test Method for Air Permeability of Textile Fabrics. In another embodiment, the first textile has a mullen burst of greater than 500 PSI. In one embodiment, the first textile 100 is acid resistant. The textile used in the filter are selected from materials that can maintain sufficient mechanical properties in the presence of acids and acidic gas at elevated temperatures (120° C., up to 400° C.).

The first textile 100 contains yarns which may be any suitable fiber. “Fiber”, in this application, as used herein includes a monofilament elongated body, a multifilament elongated body, ribbon, strip, yarn, tape, and the like. The term fiber, in this application is defined to include a yarn. The first textile 100 may contain one type of yarn or a plurality of any one or combination of the above. The yarns may be of any suitable form such as spun staple yarn, monofilament, or multifilament, single component, bi-component, or multi-component, and have any suitable cross-section shape such as circular, multi-lobal, square or rectangular (tape), and oval.

The fibers may be made of any suitable material. Because the filter may be used in flue gas environments, the fibers preferably have a melting temperature and decomposition temperature greater than the temperature of the gas that the filter 10 is filtering. Preferably, the fibers have a melting temperature greater than 250° F. More preferably, the fibers have a melting temperature greater than 400° F. The first textile 100 may include (but is not limited to) glass, aramid, polyphenylene sulfide, polyester, polyimide, polytetrafluoroethylene, ceramic materials, sulfo-aramid, polyoxadiazoles, polyetheretherketone, polyamide-imide, polypyridobisimidazoles, and mixtures and co-polymers thereof. In one embodiment, it is preferred to use polyphenylene sulfide (PPS) fibers because its acid resistance and high temperature stability.

Referring back to FIG. 1, there is shown an abating chemistry 200 on the second side 100b of the first textile 100. While the abating chemistry 200 is shown on the second side 100b of the first textile 100, it may be on both sides (100a, 100b) of the first textile or only on the first side 100a of the first textile 100.

The abating chemistry may reside only on the surface of the first textile 100, may penetrate a certain depth into the first textile 100, or may penetrate the first textile 100 completely.

The abating chemistry 200 contains an absorbent agent, an organic halogen producing agent, and optionally a binder. Some abating chemistry compositions are selected such that the organic halogen producing agent also acts as a binder. The organic halogen producing agent then serves to adhere to the adsorbent and to the second side 100b of the textile 100.

In one embodiment, the abating chemistry is applied in an amount of between 10 and 50% by weight of the first textile. In another embodiment, the coating weight of the abating chemistry is between about 2 and 200 g/m², more preferably between about 20 and 120 g/m². In one embodiment, the abating chemistry contains between about 0 and 30% wt binder, between about 30 and 50% wt absorbent agent, and between about 30 and 50% wt organic halogen producing agent. In the embodiments where the optional binder is not present, the abating chemistry may contain between about 30 and 70% wt absorbent agent and between about 30 and 70% wt organic halogen producing agent.

The abating chemistry contains an adsorbent agent. The adsorbent agent adsorbs at least a portion of the heavy metals from the gas passing through the filter. Preferably, the adsorbent agent has a BET surface area greater than 300 m²/g, more preferably greater than 600 m²/g. The adsorbent agent preferably does not melt or degrade at the flue gas temperature (about 400° F.) and is stable under the flue gas conditions (temperature, pressure, gas components, residence time, etc). A listing of possible adsorbent agents includes, but is not limited to activated carbon, molecular sieve, zeolite, and mixtures thereof. Preferably, the adsorbent is activated carbon. Activated carbon is preferred as it has been shown to adsorb a range of toxic metal pollutants including mercury pollutants and to be thermally stable. The adsorbent can be provided in the forms of a fine particles, granules, fibers, woven, knit or non-woven textiles.

The abating chemistry also contains an organic halogen producing agent, preferably in intimate contact with the adsorbent. The organic halogen producing agent degrades at a temperature of between 250 and 400° F. such that it releases at least one of the following: hydrogen halide, halide radicals, halogen gas, elemental halogen, and halogen oxides. These degradation products then react with the mercury or other heavy metals in the flue gas stream converting the elemental heavy metal into a heavy metal halide and/or metal ions which is more easily removed from the flue gas in a later process step, such as a wet scrubber of a FGD (Flue Gas Desulfurization) unit. In one embodiment, the filter converts at least a portion of the elemental mercury passing through the filter into mercury halide and/or mercury ions. In one embodiment, the organic halogen producing agent may be, but is not limited to, polyvinyl chloride, polyvinylidene chloride, polyvinyl bromide, polydibromostyrene, copolymers comprising vinyl chloride, vinylidene chloride, vinyl bromide, or dibromostyrene, halogenated polyolefins, halogenated epoxy resins, polychloroprene, chlorosulfonated polyolefins, polychloromethylstyrene, and mixtures thereof. Preferably, the organic halogen producing agent is polyvinyl chloride, polyvinylene chloride, or a copolymer comprising vinylchloride and/or vinylidene chloride monomers. Preferably, the organic halogen producing agent is a polymer. Although the Applicant do not wish to be bound by or to any particular theory, it is believed that the organic halogen producing agent slowly produces a halogen containing species, such as hydrogen halide, over a long periods of time, thus contributing to the long lasting mercury removing and mercury oxidation performance on the filter. It is also believed that the intimate contact between the halogen producing agent and the adsorbent allows synergistic combination of mercury pollutant in the gas stream and the halogen species generated to combine on the adsorbent site for efficient oxidation reaction and more effective adsorption. It is also speculated that the adsorbent may adsorb the hydrogen halide or other halogen species and catalyze the oxidation of elemental mercury adsorbed from the gas stream. Other organic halogen producing agent conceived includes aliphatic and aromatic halogen containing compounds such as halogenated wax, hexabromocyclododecane, tetrabromophthalates, brominated phenols, brominated bisphenols, quaternary ammonium halides, and the like.

The abating chemistry optionally contains a binder. The chemistry contains a binder when the organic halogen producing agent does not act as a binder or when more binding in the chemistry is desired. The binder preferably does not melt or decompose at the temperature of flue gas and therefore has a melting temperature and a decomposition temperature of greater than about 400° F. In one embodiment, the binder may be but is not limited to acrylic polymers, silicone polymer (polydimethylsiloxane, polymethylphenyloxane, and polydiphenyloxane), polyester, polyurethane, PTFE, polyolefin, organomodified silicate, and mixtures thereof.

FIG. 2 illustrates another embodiment of the invention where the filter contains a second textile 300 on the abating chemistry 200 (on the side of the chemistry opposite the first textile 100). While the second textile 300 is shown on the chemistry 200, the second textile 300 may be placed in any suitable location in the filter including on the first side 100a of the first textile 100, on the second side 100b of the first textile 100 between the textile 100 and the chemistry 200, or on the chemistry 200.

The second textile 300 may be formed from any of the materials and have any of the same properties listed as being for the first textile 100. In another embodiment, the second textile 300 may be formed from different materials and have different properties than the first textile 100. In one embodiment, the pore size of the first textile 100 is smaller than the pore size of the second textile 300. In another embodiment, the pore size of the first textile 100 is larger than the pore size of the second textile 300. In one embodiment, the second textile 300 is an activated carbon textile. The activated carbon textile as the second textile may have the organic halogen producing agent on it. This carbon textile may be used as part of the abating chemistry instead of the activated carbon or in addition to it. The carbon textile may include woven, non-woven, or knitted carbon textile made from any carbon precursors, such as regenerated cellulosic fibers, phenolic fibers, and acrylic fibers. The carbon textile may be impregnated or coated with a composition comprising the halogen producing agent described above. The carbon textile with or without the halogen producing agent may be combined with the other layers shown in FIG. 3 by lamination, needling, stitching or sewing. The carbon textile is preferably sandwiched between two layers of porous materials to protect against abrasions due to the relative weak mechanical strength of the carbon textile layer.

FIG. 3 illustrates an additional embodiment of the filter where the filter 10 has a membrane 400 on the first side 100a of the first textile 100. The membrane 400 is placed on the first side 100a such that the flue gases pass through the membrane 400 before the first textile 100 and abating chemistry 200.

For many applications, such as gas filtration, it is desirable to employ porous membranes in conjunction with the first (and optionally second) textile layers and abating chemistry. Porous membranes, for example PTFE membranes, have relatively small pores, relatively high permeability, and relatively high mechanical strength.

Use of an expanded PTFE membrane greatly enhanced the performance of filter elements because the particles collect on the surface of the expanded PTFE, rather than in the depth of the textile filter layers as was occurring in the absence of the membrane layer. Several significant advantages may be obtained using a porous membrane on the first side 100a of the first textile 100. The filter 10 may last longer because particles do not get into the first textile 100. Additionally, for cleanable systems, the cleaning energy needed to clean the particle cakes off of the filter may be lower because the surface of the membrane 400 is smooth and has a lower surface energy than the first textile layer 100.

In one preferred embodiment, the porous membrane 400 is a porous expanded polytetrafluoroethylene (PTFE) membrane. The porous PTFE membranes useful in such elements are prepared by a number of different known processes, but are preferably prepared by expanding PTFE as described in U.S. Pat. Nos. 4,187,390, 4,110,392 and 3,953,566, to obtain expanded, porous PTFE. By “porous” is meant that the membrane has an air permeability of at least 2 cubic feet per minute per square foot (cfm/ft²) at 0.5 inch water gauge (this unit is sometimes referred to as the Frazier number). Membranes having an air permeability of up to 300 cfm/ft² or more can also be used. The pores are micropores formed by the nodes and fibrils of the expanded PTFE. Preferred membranes of the present invention have an air permeability of at least 5, and more preferably at least 16, cfm/ft² at 0.5 inch water gauge, for use in gas stream filtration.

The process for using the filter to reduce heavy metals in a flue gas comprises passing a flue gas having a temperature of at least 250° F. and containing heavy metals through the filter described above, where the gas exiting the filter has a lower elemental heavy metal content because at least at least a portion of the heavy metals are converted to halogenated metals and at least a portion of the heavy metals are adsorbed by the abating chemistry. The heavy metal is preferably mercury. The textile may be manufactured in any known manufacturing method. The chemistry may be applied to the textile in known manner, preferably in a manner that retains a significant portion of the air permeability of the textile.

In one embodiment, the abating chemistry is applied to the second side of the first textile by foam coating the chemistry. Any foaming processes and foam coating processes known to an ordinary skill in the art can be used. In an exemplary foam coating process, the adsorbent (usually in the form of particles or water suspension), the halogen producing agent, and other optionally components such as foaming agent and rheology modifiers are combined and agitated with injection of air to produce a mixture having fine air bobbles embedded relatively uniformly throughout the mixture. The density of the mixture is typically used to estimate and monitor the amount of injected air. The foaming mixture usually has a density between 0.02 g/cm³ to about 0.8 g/cm³, preferably, 0.1 g/cm³ to 0.4 g/cm³. The foaming mixture is applied to the textile substrate through coating, extrusion, or other known process known to one of ordinary skills. After application, the foaming mixture is dried, preferably at elevated temperatures to remove water and entrapped air. The foamed coating allows the inclusion of sufficient amount of abating chemistry without significant reduction in air permeability. In one embodiment, the chemistry is used with a viscosity capable of trapping many air bubbles within it creating foam, the chemistry is then laid onto the material and knife or blade is used to allow only the desired quantity of material to pass into the curing oven. When the chemistry cures the entrapped air becomes voids aiding in the permeability of the material.

In one embodiment, a coal based activated carbon powder with a particle size ranging from about 1 micron to about 100 microns may be suspended in water in the presence of a polyacrylic acid and a sulfonated alkylaromatic surfactant under mechanical stirring. A suspension with 20% to 40% solid content can be prepared in this manner. The activated carbon suspension may be then combined with, and optionally with a thickening agent or a foaming agent (such as ammonium stearate and amine oxide surfactants). The mixture is then whipped inside a container to foamed an air bubble entrained foamed mixture, or processed through a foaming apparatus (foamer) to provide a foamed mixture. The mixture is subsequently applied to a surface of a textile layer by coating, spray, or extrusion. The textile with foamed mixture is then dried at elevated temperature to remove the entrained air and water for a filter medium.

In one embodiment, the first side 100a of the first textile 100 (which typically forms the outermost surface of the filter) is singed. This means that the outer surface is exposed to an open flame so that small fibers are removed by temperature and flame on the first side of textile 100. This leaves a slightly rough feeling surface on the textile absent of small fibers on the first side of textile 100; thus allowing the filter to release the dust cake more easily upon reverse pulse cleaning.

In one preferred embodiment a filter 10 is constructed as a bag using textile 100. Textile 100 sewn into a bag so that the first side (without the abating chemistry) is exposed on the outside of the bag. Filter 10 is usually constructed of a length of between 4 and 20 ft, and between 4 and 36 inches in diameter. Multiple bags are then assembled into a bag house. The bags are situated so that upon reverse pulse cleaning the released dust cake can be easily collected. The number of bags in the bag house is set to allow the desired volume of air to be cleaned in the bag house. Often times many bag houses will be required to treat the large amount of flue gas generated in large power facilities. Typically the dirty air will enter into a bag house containing a multitude of between 12 and 98 bags. The air will be pulled into the hanging bags and clean air will be pulled out the top of the bag house from inside of the bags.

### EXAMPLES

### Example 1

A foamed mixture comprising about 30 grams of a 40% activated carbon suspension, 40 grams of vinylidene chloride copolymer emulsion, VYCAR© 650×27, available from Lubrizol Advanced Materials, Inc., 30 grams water, and 2 grams of an amine oxide foaming agent, Unifroth 0529 (available from Unichem, Inc) was formed. The foamed mixture was prepared to reach a density of ˜0.16 g/cm² and was applied to an 11 oz/yd² spun laced PPS fiber non-woven and dried to result in about 2.0 oz/yd² add-on weight abating chemistry on one side of the filter textile. The non-woven textile had an air permeability of ˜40 cfm (at 125 Pa pressure) before applying the abating chemistry and ˜35 cfm (at 125 Pa pressure) after the abating chemistry was applied and dried. The air permeability after coating was small considering the significant 2 oz/yd² add-on on the textile.

### Example 2

The filter of Example 2 was the same as the filter of Example 1, except that a 17 oz/yd2 needle punched PPS non-woven textile was used.

### Example 3

The filter of Example 3 was the same as the filter of Example 1, except a vinylchloride acrylate copolymer latex, VYCAR© 460×58, was used in place of the vinylidene chloride copolymer emulsion.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A filter comprising:
a first textile having a first side and a second side, wherein the first textile is selected from the group consisting of a non-woven, woven, and knit, and wherein the first textile has an air permeability of between about 1 and 200 cfm; and
an abating chemistry on at least the second side of the first textile, wherein the chemistry comprising:
an adsorbent agent;
an organic halogen producing agent; and,
optionally a binder.

2. The filter of claim 1, wherein the first textile comprises fibers having a melting temperature greater than 400° F.

3. The filter of claim 1, wherein the first textile has an air permeability of between about 25 and 50 cfm.

4. The filter of claim 1, wherein the first textile comprises fibers selected from the group consisting of glass, aramid, polyphenylene sulfide, polyester, polyimide, polytetrafluoroethylene, ceramic materials, sulfo-aramid, polyoxadiazoles and polyetheretherketone.

5. The filter of claim 1, wherein the first textile comprises polyphenylene sulfide fibers.

6. The filter of claim 1, wherein the adsorbent agent is selected from the group consisting of activated carbon, molecular sieve, and zeolite.

7. The filter of claim 1, wherein the adsorbent agent has a BET surface area greater than about 300 m²/g.

8. The filter of claim 1, wherein the organic halogen producing agent degrades at a temperature between about 250 and 400° F.

9. The filter of claim 1, wherein the organic halogen producing agent degrades to release at least one hydrogen halide, halide radical, halogen gas, elemental halogen, or halogen oxide.

10. The filter of claim 1, wherein the organic halogen producing agent is a halogen containing polymer selected from the group consisting of polyvinyl chloride, polyvinylidene chloride, polyvinyl bromide, polydibromostyrene, copolymers comprising vinyl chloride, vinylidene chloride, vinyl bromide, or dibromostyrene, halogenated polyolefins, halogenated epoxy resins, polychloroprene, chlorosulfonated polyolefins, and polychloromethylstyrene.

11. The filter of claim 1, wherein the filter further comprises an expanded polytetrafluoroethylene membrane on the first side of the first textile.

12. The filter of claim 1, wherein the filter further comprises a second textile located on the abating chemistry, on the side of the abating chemistry opposite to the first textile, wherein the second textile comprises activated carbon fibers and wherein at least a portion of the organic halogen producing agent is disposed on the activated carbon fibers.

13. The filter of claim 1, wherein the binder is selected from the group consisting of an acrylic, silicone polymer, polyester, polyurethane, PTFE, polyolefin, and organomodified silicate.

14. The filter of claim 1, wherein filter comprises the abating chemistry in an amount of between about 10 and 50% wt of the first textile.

15. The filter of claim 1, wherein the abating chemistry comprises between about 0 and 30% wt binder, between about 30 and 50% wt absorbent agent, and between about 30 and 50% wt organic halogen producing agent.

16. The filter of claim 1, wherein the abating chemistry comprises between about 30 and 70% wt absorbent agent and between about 30 and 70% wt organic halogen producing agent.

17. A bag house comprising a plurality of filters of claim 1.

18. The process of reducing heavy metals in a flue gas comprising passing a flue gas having a temperature of at least 250° F. and containing heavy metals through a filter comprising:
a first textile having a first side and a second side, wherein the first textile is selected from the group consisting of a non-woven, woven, and knit, and wherein the first textile has an air permeability of between about 1 and 200 cfm; and
an abating chemistry on at least the second side of the first textile, wherein the chemistry comprising:
an absorbent agent;
an organic halogen producing agent; and,
optionally a binder,
wherein at least a portion of the heavy metals are converted to halogenated metals and at least a portion of the heavy metals are adsorbed by the abating chemistry.

19. The process of claim 35, wherein the heavy metal is mercury.

20. The process of forming a filter comprising:
forming a first textile having a first side and a second side, wherein the first textile is selected from the group consisting of a non-woven, woven, and knit, and wherein the first textile has an air permeability of between about 1 and 200 cfm; and
foam coating an abating chemistry on at least the second side of the first textile, wherein the chemistry comprising:
an absorbent agent;
an organic halogen producing agent; and,
optionally a binder.

21. The process of claim 39, wherein the first side of the first textile is singed.
